(19) United States
(12) Patent Application Publication
(10) Pub. No.: US 2022/0339635 A1
(43) Pub. Date: Oct. 27, 2022

(54) POWDER GRINDER

(71) Applicant: Xiaolin Zhang, Zhongshan (CN)

(72) Inventor: Xiaolin Zhang, Zhongshan (CN)

(21) Appl. No.: 17/529,538

(22) Filed: Nov. 18, 2021

(30) Foreign Application Priority Data
Apr. 26, 2021 (CN) 202120869106.0

(51) Int. Cl. B02C 7/18; B02C 11/04

(52) U.S. Cl. CPC B02C 7/188; B02C 11/04

(57) ABSTRACT

The present invention relates to the field of grinding equipment, in particular to a powder grinder, comprising a power mechanism, a grinding mechanism, and a feeding mechanism. The feeding mechanism comprises a bowl and a base. The bowl is detachably installed on the base, and the power mechanism is detachably installed on the bowl. The first discharge opening is arranged in the middle of the bowl, and the second discharge opening is arranged in the middle of the base. An adjusting plate is rotatably installed on the base. The third discharge opening is arranged in the middle of the adjusting plate. An adjusting ring is arranged between the bowl and the base. The second connecting assembly is arranged between an inner edge of the adjusting ring and an outer edge of the adjusting plate. A bearing is arranged in the bowl. One end of the bearing is connected to the power mechanism, and the other end of the bearing passes through the first discharge opening, the third discharge opening, and the second discharge opening in sequence and is connected to the grinding mechanism for separate removal and cleaning of the bowl, the base, and the grinding mechanism. When cleaning, the power mechanism can be separately detached, which effectively prevents liquid from entering the inside of the power mechanism.

### REFERENCE TO PRIOR APPLICATION

This application claims priority to Chinese Patent Application 202120869106.0, filed on Apr. 26, 2021, which is incorporated herein by reference.

### FIELD OF THE INVENTION

The present invention relates to the field of grinding equipment, in particular to a powder grinder.

### BACKGROUND OF THE INVENTION

With the improvement of people's living standard, people pay more attention to the quality of food and grain powder is very popular. Household grain powder grinders have come into being and are essential equipment in many families.

Existing powder grinders have relatively complicated structure and are not easy to install. The cutter head of the grinders generally cannot be detached and cleaned, which is prone to leave food residues in the joint of the cutter head, and cause tainted flavor when grinding different food materials. Moreover, residues may easily go bad after some time and affect health if they are not cleaned properly.

### SUMMARY OF THE INVENTION

In order to overcome the above-mentioned deficiencies, the present invention proposes a technical scheme that can solve the above-mentioned problems.

A powder grinder comprising a power mechanism, a grinding mechanism, and a feeding mechanism. The feeding mechanism comprises a bowl and a base. The bowl is detachably installed on the base, and the power mechanism is detachably installed on the bowl. The first discharge opening is arranged in the middle of the bowl, and the second discharge opening is arranged in the middle of the base. An adjusting plate is rotatably installed on the base. The third discharge opening is arranged in the middle of the adjusting plate. The first discharge opening, the third discharge opening, and the second discharge opening are connected in sequence. An adjusting ring is arranged between the bowl and the base. The adjusting ring is arranged around the adjusting plate.

The second connecting assembly is arranged between the inner edge of the adjusting ring and the outer edge of the adjusting plate. A bearing is arranged in the bowl. One end of the bearing is connected to the power mechanism, and the other end of the bearing passes through the first discharge opening, the third discharge opening, and the second discharge opening in sequence and is connected to the grinding mechanism. The first connecting assembly is arranged between the third discharge opening and the bearing.

Further, the grinding mechanism comprises a grinding disc, a grinding knife, a fixed part, and the first convex ring. The grinding knife and the grinding disc are sequentially sleeved on the bearing. The fixed part is detachably installed on the other end of the bearing. The bottom of the grinding knife is connected to the fixed part. The first convex ring is installed at the bottom of the second discharge opening, and the bottom of the grinding disc is connected to the inner edge of the first convex ring.

Further, the first connecting assembly comprises the first connecting rod, and the second convex ring. The second convex ring is sleeved on the bearing. Two ends of the first connecting rod are respectively connected to the outer edge of the first convex ring and the inner edge of the third discharge opening. A plurality of first connecting rods is arranged at equal intervals around the second convex ring.

Further, the second connecting assembly comprises the second connecting rod and slots. The slots are arranged at the inner edge of the adjusting ring, and both ends of the second connecting rod are respectively connected to the outer edge of the adjusting disc and the slots.

Further, the power mechanism comprises a shell assembly, a motor, a circuit board, and a connecting piece. The shell assembly is detachably installed on the bowl. The circuit board and the motor are both installed inside the shell assembly. The output shaft of the motor passes through the bottom of the shell assembly and is connected to one end of the connecting piece, and the other end of the connecting piece is connected to one end of the bearing.

Further, the shell assembly comprises an inner shell and an outer shell. The outer shell is sleeved on the inner shell. The inner shell comprises an upper shell and a bottom shell. One end of the bottom shell is connected to the bowl, and the other end of the bottom shell is connected to the upper shell. The motor is installed on the bottom shell. The circuit board is installed on the upper shell on which a silicone button is arranged. The silicone button is electrically connected to the circuit board, and a power port is arranged on the bottom shell.

Further, a rotating sleeve is sleeved on the bearing. A plurality of partitions is arranged between the rotating sleeve and the inner wall of the bowl. The partitions are arranged at equal intervals around the rotating sleeve.

Further, a cup is detachably installed at the bottom of the base.

Further, a support sleeve is arranged on the base, and a support rod is arranged at the bottom of the bowl. The support rod is detachably installed in the support sleeve.

Compared with the Prior Art, the Present Invention has the Following Beneficial Effects:

A powder grinder works under the joint action of the bowl, base, power mechanism, bearing, and grinding mechanism. When cleaning, the power mechanism can be detached and separated from the bowl, base and grinding mechanism to effectively prevent liquid from entering the inside of the power mechanism and extend the service life of the powder grinder. In addition, the bowl, the base, and the grinding mechanism can be separately detached and cleaned, which effectively prevents food residue and protects health. With the joint action of the adjusting plate, the adjusting ring, the first connecting assembly, and the second connecting assembly, the adjusting ring is rotated to drive the second connecting assembly to rotate, and the second connecting assembly drives the adjusting plate to rotate to adjust the grind fineness. The adjusting ring is arranged between the bowl and the base for easy adjustment of grind fineness during operation.

### DESCRIPTION OF THE DRAWINGS

In order to illustrate the technical solutions more clearly in the embodiments of the present invention or the prior art, the drawings required for illustration of the embodiments or the prior art will be briefly described below. Obviously, the drawings in the following description are only part of the embodiments of the present invention, and those of ordinary skill in the art may obtain other drawings without creative work based on them.

FIG. 1 is a structural schematic diagram of the present invention.

FIG. 2 is an exploded view of the present invention.

FIG. 3 is a structural schematic diagram of the first connecting assembly of the present invention.

FIG. 4 is a structural schematic diagram of Part A in FIG. 1.

FIG. 5 is a structural schematic diagram of the bowl of the present invention.

FIG. 6 is a structural schematic diagram of the support rod of the present invention.

Description of the reference numerals: 1. Power mechanism, 2. Grinding mechanism, 3. Feeding mechanism, 4. Cup, 8. Shell assembly, 9. Motor, 10. Circuit board, 11. Connecting piece, 12. Bearing, 13. Grinding disc, 14. Grinding knife, 15. Fixed part, 16. First convex ring, 17. Bowl, 18. Base, 19. First discharge opening, 20. Second discharge opening, 21. Adjusting plate, 22. Third discharge opening, 23. Adjusting ring, 24. First connecting assembly, 25. Second connecting assembly, 26. First connecting rod, 27. Second convex ring, 28. Rotating sleeve, 29. Partition, 30. Inner shell, 31. Outer shell, 32. Upper shell, 33. Bottom shell, 34. Silicone button, 35. Power port, 36. Support sleeve, 37. Support rod, 38. Second connecting rod, 39. Slot.

### DETAILED DESCRIPTION OF PREFERRED EMBODIMENTS

The technical solutions provided in the embodiments of the present invention will be described clearly and completely below. Apparently, the described embodiments are merely a part rather than all the embodiments of the present invention. All other embodiments made by those of ordinary skill in the art based on the embodiments of the present invention without creative work shall fall within the protection scope of the present invention.

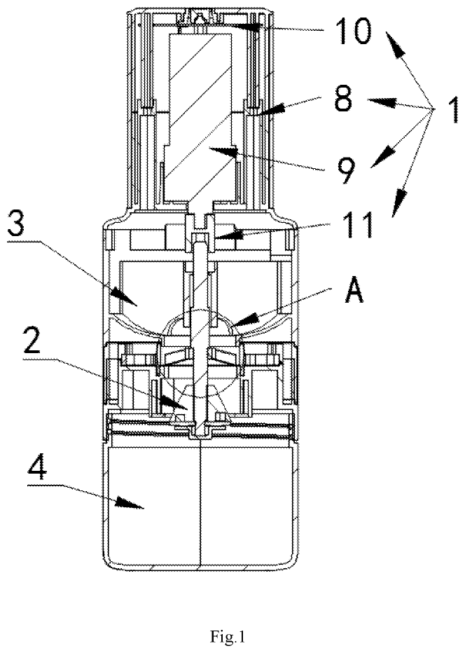

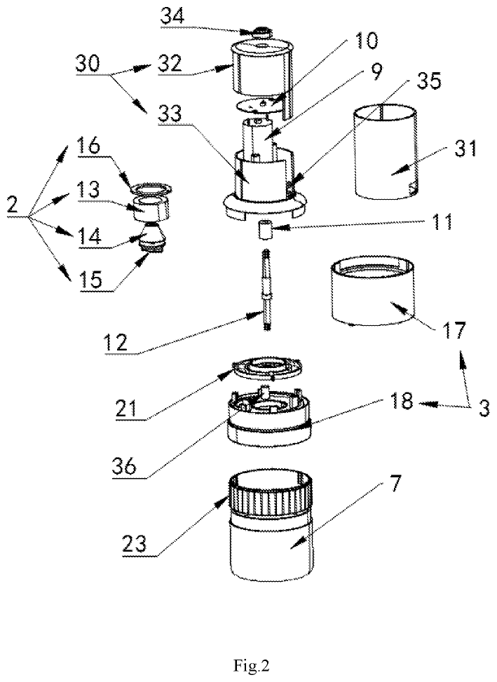

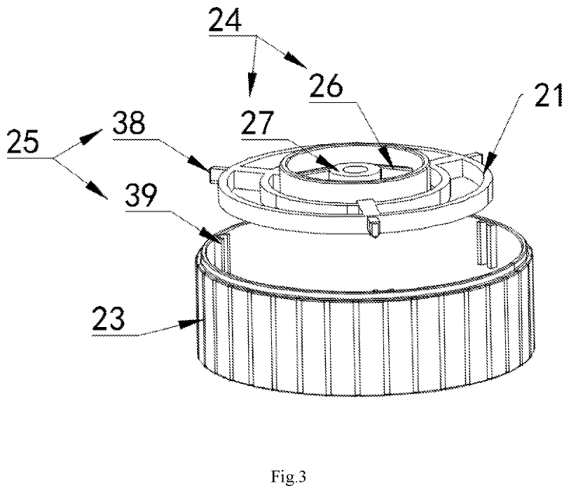

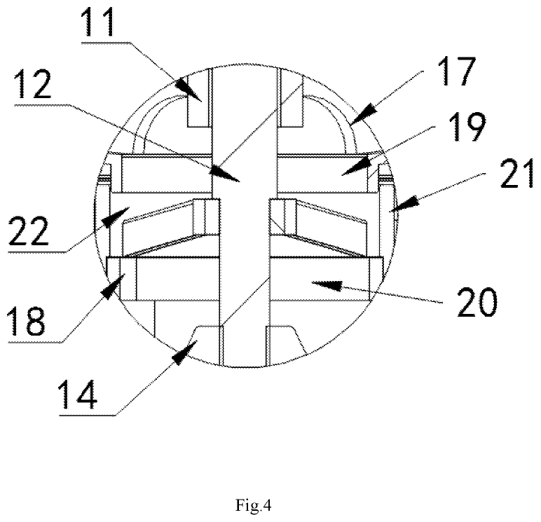

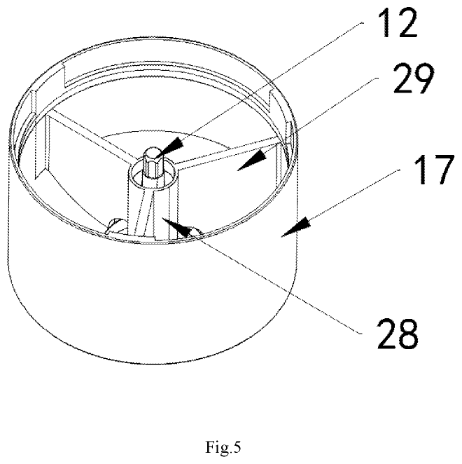

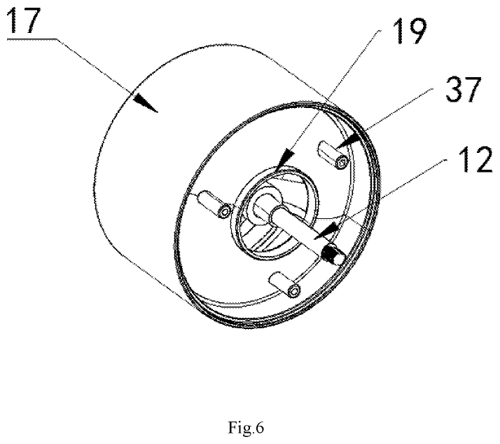

As shown in FIGS. 1-6, in the embodiments of the present invent, a powder grinder is provided, comprising a power mechanism (1), a grinding mechanism (2), and a feeding mechanism (3). The feeding mechanism (3) comprises a bowl (17) and a base (18). The bowl (17) is detachably installed on the base (18), and the power mechanism (1) is detachably installed on the bowl (17). The first discharge opening (19) is arranged in the middle of the bowl (17), and the second discharge opening (20) is arranged in the middle of the base (18). An adjusting plate (21) is rotatably installed on the base (18). The third discharge opening (22) is arranged in the middle of the adjusting plate (21). The first discharge opening (19), the third discharge opening (22), and the second discharge opening (20) are connected in sequence. An adjusting ring (23) is arranged between the bowl (17) and the base (18). The adjusting ring (23) is arranged around the adjusting plate (21). The second connecting assembly (25) is arranged between the inner edge of the adjusting ring (23) and the outer edge of the adjusting plate (21). A bearing (12) is arranged in the bowl (17). One end of the bearing (12) is connected to the power mechanism (1), and the other end of the bearing (12) passes through the first discharge opening (19), the third discharge opening (22), and the second discharge opening (20) in sequence and is connected to the grinding mechanism (2). The first connecting assembly (24) is arranged between the third discharge opening (22) and the bearing (12).

A powder grinder works under the joint action of the bowl (17), the base (18), the power mechanism (1), the bearing (12), and the grinding mechanism (2). When cleaning, the power mechanism (1) can be detached and separated from the bowl (17), the base (18) and the grinding mechanism (2) to effectively prevent liquid from entering the inside of the power mechanism (1) and extend the service life of the powder grinder. In addition, the bowl (17), the base (18), and the grinding mechanism (2) can be separately detached and cleaned, which effectively prevents food residue and protects health. With the joint action of the adjusting plate (21), the adjusting ring (23), the first connecting assembly (24), and the second connecting assembly (25), the adjusting ring (22) is rotated to drive the second connecting assembly (25) to rotate, and the second connecting assembly (25) drives the adjusting plate (21) to rotate to adjust the grind fineness. The adjusting ring (23) is arranged between the bowl (17) and the base (18) for easy adjustment of grind fineness during operation.

In the present embodiment, the grinding mechanism (2) comprises a grinding disc (13), a grinding knife (14), a fixed part (15), and the first convex ring (16). The grinding knife (14) and the grinding disc (13) are sequentially sleeved on the bearing (12). The fixed part (15) is detachably installed on the other end of the bearing (12), and connected to the bottom of the grinding knife (14). The first convex ring (16) is detachably installed at the bottom of the second discharge opening (20). The bottom of the grinding disc (13) is connected to the inner edge of the first convex ring (16). With the joint action of the grinding disc (13), the grinding knife (14), the fixed part (15), and the first convex ring (16), when food material passes through the bowl (17) and falls between the grinding disc (13) and the grinding knife (14), the bearing drives the grinding knife to rotate to grind food material and ground food material falls into the cup. The equipment has a simple structure and is easy to install or disassemble.

In the present embodiment, the first connecting assembly (24) comprises the first connecting rod (26), and the second convex ring (27). The second convex ring (27) is sleeved on the bearing (12). Two ends of the first connecting rod (26) are respectively connected to the outer edge of the first convex ring (16) and the inner edge of the third discharge opening (22). A plurality of first connecting rods (26) is arranged at equal intervals around the second convex ring (27). With the joint action of the first connecting rod (26) and the second convex ring (27), the adjusting plate (21) is effectively supported and smoothly rotates.

In the present embodiment, the second connecting assembly (25) comprises the second connecting rod (38), and slots (39). The slots (39) are arranged at the inner edge of the adjusting ring (23). Two ends of the second connecting rod (38) are respectively connected to the outer edge of the adjusting plate (21) and the slots (39). The joint action of the second connecting rod (38) and the slots (39) enable the adjusting ring (23) to effectively drive the adjusting plate (21) to rotate through the slots (39) and the second connecting rod (38).

In the present embodiment, the power mechanism (1) comprises a shell assembly (8), a motor (9), a circuit board (10), and a connecting piece (11). The shell assembly (8) is installed on the bowl (17). The circuit board (10) and the motor (9) are both installed inside the shell assembly (8). The output shaft of the motor (9) passes through the bottom of the shell assembly (8) and is connected to one end of the connecting piece (11), and the other end of the connecting piece (11) is connected to one end of the bearing (12). With the joint action of the shell assembly (8), the motor (9), the circuit board (10), and the connecting piece (11), the motor (9) drives the bearing (12) and the grinding knife (14) to rotate through the connecting piece (11) to effectively grind food materials.

In the present embodiment, the shell assembly (8) comprises an inner shell (30) and an outer shell (31). The outer shell (31) is sleeved on the inner shell (30). The inner shell (30) comprises an upper shell (32) and a bottom shell (33). One end of the bottom shell (33) is connected to the bowl (17), and the other end of the bottom shell (33) is connected to the upper shell (32). The motor (9) is installed on the bottom shell (33). The circuit board is installed on the upper shell (32) on which a silicone button (34) is arranged. The silicone button (34) is electrically connected to the circuit board, and a power port (35) is arranged on the bottom shell (33). With the joint action of the bottom shell (33), the upper shell (32), and the outer shell (31), the motor (9) and the circuit board can be effectively installed.

In the present embodiment, a rotating sleeve (28) is sleeved on the bearing (12). A plurality of partitions (29) is arranged between the rotating sleeve (28) and the inner wall of the bowl (17). The partitions (29) are arranged at equal intervals around the rotating sleeve (28). Due to the arrangement of the rotating sleeve (28) and the partitions (29), the internal space of the bowl (17) is effectively partitioned.

In the present embodiment, a cup (4) is detachably installed at the bottom of the base (18). The arrangement of the cup (4) allows the ground food materials to fall into the cup (4) to effectively collect them.

In the present embodiment, a support sleeve (36) is arranged on the base (18), and a support rod (37) is arranged at the bottom of the bowl (17). The support rod (37) is detachably installed in the support sleeve (36). With the joint action of the support sleeve (36) and the support rod (37), the base (18) supports the bowl (17) more effectively.

It is obvious to those skilled in the art that the present invention is not limited to the details of the above exemplary embodiments, and the present invention may be embodied in other specific forms without departing from its spirit or basic characteristics. Therefore, it is to be considered that the embodiments disclosed are illustrative and not restrictive in all the aspects. The scope of the present invention is defined by the appended claims rather than the foregoing description. All changes that fall within the scope of the equivalents of the claims should be included.

What is claimed is:

1. A powder grinder comprising a power mechanism (1), a grinding mechanism (2), and a feeding mechanism (3). wherein the feeding mechanism (3) comprises a bowl (17) and a base (18). The bowl (17) is detachably installed on the base (18), and the power mechanism (1) is detachably installed on the bowl (17). The first discharge opening (19) is arranged in the middle of the bowl (17), and the second discharge opening (20) is arranged in the middle of the base (18). An adjusting plate (21) is rotatably installed on the base (18). The third discharge opening (22) is arranged in the middle of the adjusting plate (21). The first discharge opening (19), the third discharge opening (22), and the second discharge opening (20) are connected in sequence. An adjusting ring (23) is arranged between the bowl (17) and the base (18). The adjusting ring (23) is arranged around the adjusting plate (21). The second connecting assembly (25) is arranged between an inner edge of the adjusting ring (23) and an outer edge of the adjusting plate (21). A bearing (12) is arranged in the bowl (17). One end of the bearing (12) is connected to the power mechanism (1), and the other end of the bearing (12) passes through the first discharge opening (19), the third discharge opening (22), and the second discharge opening (20) in sequence and is connected to the grinding mechanism (2). The first connecting assembly (24) is arranged between the third discharge opening (22) and the bearing (12).

2. The powder grinder according to claim 1, wherein the grinding mechanism (2) comprises a grinding disc (13), a grinding knife (14), a fixed part (15), and the first convex ring (16). The grinding knife (14) and the grinding disc (13) are sequentially sleeved on the bearing (12). The fixed part (15) is detachably installed on the other end of the bearing (12), and is connected to the bottom of the grinding knife (14). The first convex ring (16) is detachably installed at the bottom of the second discharge opening (20). The bottom of the grinding disc (13) is connected to an inner edge of the first convex ring (16).

3. The powder grinder according to claim 1, wherein the first connecting assembly (24) comprises the first connecting rod (26), and the second convex ring (27). The second convex ring (27) is sleeved on the bearing (12). Two ends of the first connecting rod (26) are respectively connected to an outer edge of the first convex ring (16) and an inner edge of the third discharge opening (22). A plurality of the first connecting rods (26) is arranged at equal intervals around the second convex ring (27).

4. The powder grinder according to claim 1, wherein the second connecting assembly (25) comprises the second connecting rod (38), and slots (39). The slots (39) are arranged at the inner edge of the adjusting ring (23). Two ends of the second connecting rod (38) are respectively connected to the outer edge of the adjusting plate (21) and the slots (39).

5. The powder grinder according to claim 1, wherein the power mechanism (1) comprises a shell assembly (8), a motor (9), a circuit board (10), and a connecting piece (11). The shell assembly (8) is installed on the bowl (17). The circuit board (10) and the motor (9) are both installed inside the shell assembly (8). The output shaft of the motor (9) passes through the bottom of the shell assembly (8) and is connected to one end of the connecting piece (11), and the other end of the connecting piece (11) is connected to one end of the bearing (12).

6. The powder grinder according to claim 5, wherein the shell assembly (8) comprises an inner shell (30) and an outer shell (31). The outer shell (31) is sleeved on the inner shell (30). The inner shell (30) comprises an upper shell (32) and a bottom shell (33). One end of the bottom shell (33) is connected to the bowl (17), and the other end of the bottom shell (33) is connected to the upper shell (32). The motor (9) is installed on the bottom shell (33). A circuit board is installed on the upper shell (32) on which a silicone button (34) is arranged. The silicone button (34) is electrically connected to the circuit board, and a power port (35) is arranged on the bottom shell (33).

7. The powder grinder according to claim 1, wherein a rotating sleeve (28) is sleeved on the bearing (12). A plurality of partitions (29) is arranged between the rotating sleeve (28) and the inner wall of the bowl (17). The partitions (29) are arranged at equal intervals around the rotating sleeve (28).

8. The powder grinder according to claim 1, wherein a cup (4) is detachably installed at the bottom of the base (18).

9. The powder grinder according to claim 1, wherein a support sleeve (36) is arranged on the base (18), and a support rod (37) is arranged at the bottom of the bowl (17). The support rod (37) is detachably installed in the support sleeve (36).
